(19) United States
(12) Patent Application Publication
(10) Pub. No.: US 2020/0300415 A1
(43) Pub. Date: Sep. 24, 2020

(54) CONTAINER FOR TRANSPORTING AND STORING CYLINDERS AND METHOD FOR PLACING CYLINDERS IN A CONTAINER

(71) Applicants: Oleg Stanislavovich KLUNIN, Vsevolozhskiy raion (RU); Oleg Evgenievich BOGACHEK, Saint Petersburg (RU)

(72) Inventors: Oleg Stanislavovich KLUNIN, Vsevolozhskiy raion (RU); Oleg Evgenievich BOGACHEK, Saint Petersburg (RU)

(21) Appl. No.: 16/089,573

(22) PCT Filed: Mar. 6, 2017
(86) PCT No.: PCT/RU2017/000116

§ 371 Date: Sep. 28, 2018

(30) Foreign Application Priority Data
Mar. 30, 2016 (RU) 2016111965

(51) Int. Cl. F17C 13/08; B65D 19/02; B65D 88/12

(52) U.S. Cl. CPC F17C 13/084; B65D 19/02; B65D 88/123; B65D 2519/00532; F17C 2205/0332; F17C 2201/0104; F17C 2205/0352; F17C 2221/033; F17C 2205/0107

(57) ABSTRACT

The invention relates to the field of transportation and storage of gas cylinders, and specifically to a container for gas cylinders, in particular, cylinders for pressurized or liquefied gas, a method for arranging gas cylinders in the container, in particular, cylinders for pressurized or liquefied gas, and a container with gas cylinders, in particular, cylinders for pressurized or liquefied gas. The container for gas cylinders having an outer diameter ranged from 480 mm to 520 mm and capacity ranged from over 350 l to 430 l comprises a framework and at least one pipeline positioned to be connected with the gas cylinders in the upper part of the framework. The method for arranging gas cylinders in a container, the gas cylinders having an outer diameter ranged from 480 mm to 520 mm and capacity ranged from over 350 l to 430 l, the method comprising the steps of arranging the gas cylinders in a framework of the container; and connecting at least one pipeline is with the gas cylinders in the upper part of the framework. The container with the gas cylinders comprises a framework; at least one gas cylinder having an outer diameter ranged from 480 mm to 520 mm and capacity ranged from over 350 l to 430 l, the at least one gas cylinder arranged in the framework; and at least one pipeline connected with the at least one gas cylinder in the upper part of the framework. The technical effect involves an increase in capacity of a container for gas cylinders when the gas cylinders are arranged in the container, the container having a length from 2,986 mm to 2,991 mm (according to GOST R 53350-2009), width from 2,433 mm to 2,438 mm (according to GOST R 53350-2009) and height from 2,891 mm to 2,896 mm, or length from 6,052 mm to 6,058 mm (according to GOST R 53350-2009), width from 2,433 mm to 2,438 mm (according to GOST R 53350-2009) and height from 2,891 mm to 2,896 mm, or length from 9,115 mm to 9,125 mm (according to GOST R 53350-2009), width from 2,433 mm to 2,438 mm (according to GOST R 53350-2009) and height from 2,891 mm to 2,896 mm (according to GOST R 53350-2009). The capacity of a container is considered as the total capacity of the gas cylinders contained therein.

### TECHNICAL FIELD

The present invention relates to the field of transportation and storage of gas cylinders, and specifically to a container for gas cylinders, in particular, cylinders for pressurized or liquefied gas, to a method for arranging gas cylinders in the container, in particular, cylinders for pressurized or liquefied gas, and to a container with the gas cylinders, in particular, cylinders for pressurized or liquefied gas.

### BACKGROUND

Well known containers for gas cylinders are intended for gas injection into the cylinders arranged in a container, gas storage in the cylinders, gas transportation in the cylinders, and gas dispensing from the cylinders to consumers.

An example of such a container for gas cylinders is described in CN2425051. The container comprises a framework, a cluster of gas cylinders in a vertical position, a securing support, a pipeline for gas supply, and a conveying pipe located in an upper part of the container. In such a container, the gas cylinders are mounted in the framework and the pipeline for gas supply and conveying pipe are connected in the upper part of the framework.

Further, Series 1 freight containers are also used for transporting and storing gas cylinders, the containers having a length from 2,986 mm to 2,991 mm (according to GOST R 53350-2009), width from 2,433 mm to 2,438 mm (according to GOST R 53350-2009) and height from 2,891 mm to 2,896 mm, or length from 6,052 mm to 6,058 mm (according to GOST R 53350-2009), width from 2,433 mm to 2,438 mm (according to GOST R 53350-2009) and height from 2,891 mm to 2,896 mm, or length from 9,115 mm to 9,125 mm (according to GOST R 53350-2009), width from 2,433 mm to 2,438 mm (according to GOST R 53350-2009) and height from 2,891 mm to 2,896 mm (according to GOST R 53350-2009).

Presently, 20ft containers for gas cylinders manufactured by Xperion are widely used, e.g. the X-Store container with capacity of 19,250 l capable of carrying 5,650 m³ of natural gas in 55 vertically arranged cylinders having an outer diameter of 505 mm and capacity of 350 l, wherein the operating pressure is 250 bar, or containers manufactured by Hexagon, e.g. the Smartstore container with capacity of 18,000 l capable of carrying 5,400 m³ of natural gas in 40 horizontally arranged cylinders having capacity of 450 l, wherein the operating pressure is 250 bar.

Table 1 below is a summary of parameters for the above 20ft containers known in the art.

TABLE 1

| Container | V_{co}, l | V_{png}, m³ | V_{cy}, l | N |
|---|---|---|---|---|
| X-Store | 19,250 | 5,650 | 350 | 55 |
| Smartstore | 18,000 | 5,400 | 450 | 40 |

Table 1 contains the following references:
V_{co}—overall (total) capacity of gas cylinders arranged in the container;
V_{png}—volume of compressed natural gas;
V_{cy}—gas cylinder capacity;
N—number of gas cylinders in the container.

Despite the large variety of available containers for transporting and storing gas cylinders, there is a need to create a container for gas cylinders, a method for arranging gas cylinders in the container and a container with the gas cylinders allowing to increase the amount of transported and stored compressed gas in cylinders in the inner space of the container for gas cylinders, the container having a length from 2,986 mm to 2,991 mm (according to GOST R 53350-2009), width from 2,433 mm to 2,438 mm (according to GOST R 53350-2009) and height from 2,891 mm to 2,896 mm, or length from 6,052 mm to 6,058 mm (according to GOST R 53350-2009), width from 2,433 mm to 2,438 mm (according to GOST R 53350-2009) and height from 2,891 mm to 2,896 mm, or length from 9,115 mm to 9,125 mm (according to GOST R 53350-2009), width from 2,433 mm to 2,438 mm (according to GOST R 53350-2009) and height from 2,891 mm to 2,896 mm (according to GOST R 53350-2009).

Table 2 below is a summary of parameters for the above containers.

TABLE 2

| | L, mm | | B, mm | | H, mm | |
|---|---|---|---|---|---|---|
| Container | Value | Tolerance | Value | Tolerance | Value | Tolerance |
| 10 ft container | 2,991 | 0-5 | 2,438 | 0-5 | 2,896 | 0-5 |
| 20 ft container | 6,058 | 0-6 | 2,438 | 0-5 | 2,896 | 0-5 |
| 30 ft container | 9,125 | 0-10 | 2,438 | 0-5 | 2,896 | 0-5 |

Table 2 contains the following references:
L—container length;
B—container width;
H—container height.

### SUMMARY

The aim of the present invention is to provide a container for gas cylinders, a method for arranging gas cylinders in the container and further to provide a container with the gas cylinders allowing to increase the amount of transported and stored compressed gas in cylinders in the inner space of the container for gas cylinders, the container having a length from 2,986 mm to 2,991 mm (according to GOST R 53350-2009), width from 2,433 mm to 2,438 mm (according to GOST R 53350-2009) and height from 2,891 mm to 2,896 mm, or length from 6,052 mm to 6,058 mm (according to GOST R 53350-2009), width from 2,433 mm to 2,438 mm (according to GOST R 53350-2009) and height from 2,891 mm to 2,896 mm, or length from 9,115 mm to 9,125 mm (according to GOST R 53350-2009), width from 2,433 mm to 2,438 mm (according to GOST R 53350-2009) and height from 2,891 mm to 2,896 mm (according to GOST R 53350-2009).

The aim is achieved by a container for gas cylinders having an outer diameter ranged from 480 mm to 520 mm and capacity ranged from over 350 l to 430 l, the container comprising a framework and at least one pipeline positioned to be connected with the gas cylinders in an upper part of the framework. Further, the aim is achieved by a method for arranging gas cylinders in a container, the gas cylinders having an outer diameter ranged from 480 mm to 520 mm and capacity ranged from over 350 l to 430 l, the method comprising the steps of arranging the gas cylinders in a framework of the container; and connecting at least one pipeline is with the gas cylinders in an upper part of the framework. Further, the aim is achieved by a container with the gas cylinders, the container comprising a framework; at least one gas cylinder having an outer diameter ranged from 480 mm to 520 mm and capacity ranged from over 350 l to 430 l, the at least one gas cylinder arranged in the framework; and at least one pipeline connected with the at least one gas cylinder in an upper part of the framework.

The container for gas cylinders, the method for arranging gas cylinders in the container and the container with gas cylinders provide technical effect of increasing capacity of a container for gas cylinders providing the latter are arranged in the container, the container having a length from 2,986 mm to 2,991 mm (according to GOST R 53350-2009), width from 2,433 mm to 2,438 mm (according to GOST R 53350-2009) and height from 2,891 mm to 2,896 mm, or length from 6,052 mm to 6,058 mm (according to GOST R 53350-2009), width from 2,433 mm to 2,438 mm (according to GOST R 53350-2009) and height from 2,891 mm to 2,896 mm, or length from 9,115 mm to 9,125 mm (according to GOST R 53350-2009), width from 2,433 mm to 2,438 mm (according to GOST R 53350-2009) and height from 2,891 mm to 2,896 mm (according to GOST R 53350-2009).

The capacity of a container is considered as the total capacity of the gas cylinders contained therein.

Preferably, the container comprises means for fastening the gas cylinders to the framework.

Preferably, the at least one pipeline is connectable with the gas cylinders via at least one connection fitting.

In the prior art, a stop valve is used for connection of a pipeline with a gas cylinder. In the present invention, using a connection fitting instead of a stop valve for connection of a pipeline with a gas cylinder provides the additional technical effect involving an increase in the length of a gas cylinder suitable for its arrangement in the container in a stand-up position and, consequently, an increase in the gas cylinder capacity. In the present specification, the length of a gas cylinder is considered as the length of a gas cylinder without valves and fasteners mounted on its necks.

In another preferred embodiment, the means for fastening gas cylinders to the framework are configured to provide gas cylinders fastening to the upper part of the framework and/or the lower part of the framework.

In another preferred embodiment, the means for fastening gas cylinders to the framework comprise at least one recess configured to receive the gas cylinder in a stand-up position.

Receiving the gas cylinder in the recess provides secure fastening of the gas cylinder to the framework to provide safe transportation of the gas cylinder in the container.

In another preferred embodiment, the recess is a dome-shaped bowl with a centering hole.

In another preferred embodiment, the means for fastening gas cylinders to the framework comprise at least one insert located in the lower part of the framework and/or the upper part of the framework.

In another preferred embodiment, the means for fastening gas cylinders to the framework are configured to fasten the gas cylinders to the upper part of the framework, thus restricting mobility of upper parts of the gas cylinders relative to the container.

In another preferred embodiment, the means for fastening gas cylinders to the framework comprise at least one nut mountable on a gas cylinder neck.

In another preferred embodiment, the means for fastening gas cylinders to the framework are configured to fasten the gas cylinders in a stand-up position in a checkerboard pattern.

In another preferred embodiment, the means for fastening gas cylinders to the framework comprise at least two damping inserts mountable on a gas cylinder neck, thus restricting mobility of upper and lower parts of the gas cylinders relative to the container.

In another preferred embodiment, the container has a length from 2,986 mm to 2,991 mm, a width from 2,433 mm to 2,438 mm and a height from 2,891 mm to 2,896 mm.

In another preferred embodiment, the container has the length from 6,052 mm to 6,058 mm, a width from 2,433 mm to 2,438 mm and a height from 2,891 mm to 2,896 mm.

In another preferred embodiment, the container has a length from 9,115 mm to 9,125 mm, a width from 2,433 mm to 2,438 mm and a height from 2,891 mm to 2,896 mm.

It should be noted that any reference in the present specification (including the description and the accompanying claims) to a quantity value range means that all the values of the respective quantity including the boundary values are within the range.

In another preferred embodiment, the framework is a metal load-bearing framework.

In another preferred embodiment, the container comprises means for controlling at least one pipeline, the means comprising at least one pressure gauge.

In another preferred embodiment, the container is intended for use with gas cylinders having an outer diameter of 505 (+10; −5) mm and capacity of 400 (±15) l.

In another preferred embodiment, the gas cylinders are arranged in the container framework in a stand-up position in a checkerboard pattern.

Arranging gas cylinders in the framework in a stand-up position in a checkerboard pattern provides an increased container capacity for the gas cylinders providing the latter are arranged in the container. In the present specification, the capacity of a container is considered as the total capacity of the gas cylinders contained therein.

In another preferred embodiment, the gas cylinders are fastened to the framework.

In another preferred embodiment, the gas cylinders are fastened to an upper part of the framework and/or a lower part of the framework.

In another preferred embodiment, at least one gas cylinder in a stand-up position is fastened to the lower part of the framework by its insertion into a recess configured as a dome-shaped bowl with a centering hole.

In another preferred embodiment, at least one gas cylinder in a stand-up position is fastened to the upper part of the framework, thus restricting mobility of an upper part of the gas cylinder relative to the container.

In another preferred embodiment, the at least one gas cylinder is fastened to the upper and/or lower part of the framework by fastening a gas cylinder neck to the container framework using a nut mounted on the gas cylinder neck.

In another preferred embodiment, the method for arranging gas cylinders in a container is intended for arranging gas cylinders having an outer diameter of 505 (+10; −5) mm and capacity of 400 (±15) l.

In another preferred embodiment, the at least one gas cylinder is fastened to the framework using at least two damping inserts mountable on a gas cylinder neck, thus restricting mobility of upper and lower parts of the gas cylinders relative to the container.

In another preferred embodiment, the at least one gas cylinder is a gas cylinder for natural gas.

In another preferred embodiment, the at least one gas cylinder is a gas cylinder for pressurized or liquefied gas.

In another preferred embodiment, the at least one gas cylinder is fastened to the framework.

In another preferred embodiment, the at least one gas cylinder is fastened to an upper part of the framework and/or a lower part of the framework.

In another preferred embodiment, fastening of the at least one gas cylinder to the lower part of the framework is provided by insertion of the at least one gas cylinder in a stand-up position into a recess configured as a dome-shaped bowl with a centering hole.

In another preferred embodiment, fastening of the at least one gas cylinder to the upper and/or lower part of the framework is provided by fastening a gas cylinder neck to the container framework using a nut mounted on the gas cylinder neck, thus restricting mobility of the upper and/or lower part of the gas cylinder relative to the container.

In another preferred embodiment, at least one gas cylinder in a stand-up position is fastened to the upper part of the framework, thus restricting mobility of an upper part of the gas cylinder relative to the container.

In another preferred embodiment, the at least one gas cylinder comprises at least one neck and a connection fitting mounted on the at least one neck and connectable with the at least one pipeline.

In another preferred embodiment, the at least one gas cylinder comprises at least one safety valve.

In another preferred embodiment, the container comprises means for controlling at least one pipeline, the means comprising at least one pressure gauge and/or at least one control valve.

In another preferred embodiment, the container comprises at least one gas cylinder having an outer diameter of 505 (+10; −5) mm and capacity of 400 (±15) l.

In another preferred embodiment, the at least one gas cylinder is fastened to the framework using at least two damping inserts mountable on a gas cylinder neck, thus restricting mobility of upper and lower parts of the gas cylinders relative to the container.

The means for fastening gas cylinders to the framework and control means provide secure and safe handling of the gas cylinders placed in the container.

Positional numbers

1—container;

2—gas cylinders;

3—framework;

4—pipelines;

5 —pressure gauges;

### BRIEF DESCRIPTION OF THE FIGURES

FIG. 1 shows a schematic top view, a side view and two end views of a container for gas cylinders according to a preferred embodiment of the present invention.

### DETAILED DESCRIPTION OF THE EMBODIMENTS

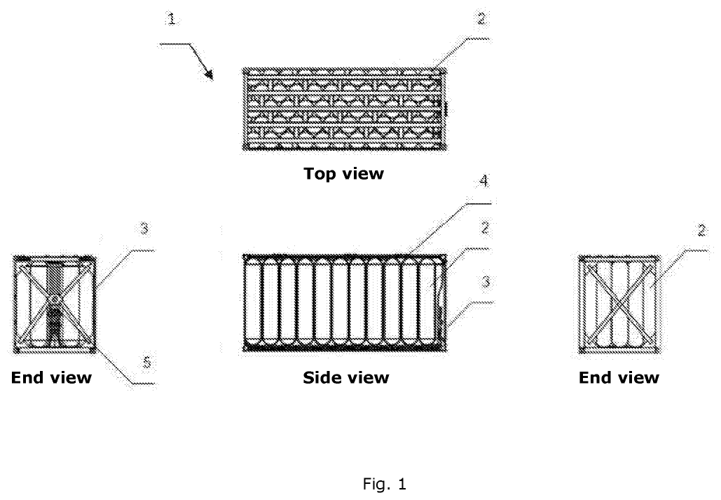

FIG. 1 shows a schematic top view, a side view and two end views of a container for gas cylinders according to a preferred embodiment of the present invention. The container 1 is intended for transportation and storage of gas cylinders 2 which can be arranged in the framework 3 of the container 1.

Preferably, the framework 3 is a metal load-bearing framework composed of metal beams; however, it can be composed of any other elements suitable for arrangement inside the framework 3 of the gas cylinders 2 which provide a sufficient security and safety of the container 1 structure during its transportation, if required.

According to an embodiment of the present invention, the gas cylinders 2 are gas cylinders for pressurized gas. Preferably, the cylinders 2 are gas cylinders for pressurized gas, in particular, gas cylinders for compressed natural gas having physical and chemical properties which comply with GOST 27577-2000. According to the present invention, the gas cylinders 2 can also be used for other pressurized or liquefied gases which do not have an aggressive effect on the materials of the gas cylinder impermeable and/or load-bearing shells, if required. The gases which can be put into the gas cylinders 2, according to the present invention, are not limited to those listed above.

The gas cylinder comprises an outer shell and an inner shell (liner).

Table 3 illustrates the effect of various inner shell materials on operating parameters of a gas cylinder.

Calculations were carried out for inner shells of various materials having a length L2=2,710 mm, an outer diameter of 470 mm and identical structural strength.

TABLE 3

| | σₛ, MPa | | | |
|---|---|---|---|---|
| Inner shell | (kilogram- | | | |
| material | force per cm²) | hᵢₛₘᵢₙ, mm | hᵢₛ, mm | V, l |
| AMg5M | 255 (2,600) | 8.0 | 10 ± 2 | 397 |
| AMg6M | 315 (3,200) | 6.5 | 8 ± 1.5 | 404 |
| ADO | 60 (610) | 34 | 40 ± 6 | 293 |
| 12KH18N10T | 530 (5,400) | 4.0 | 4.5 ± 0.5 | 417 |
| Tin-free | 392 (4,000) | 5.2 | 7 ± 1.8 | 408 |
| casting bronze | | | | |
| BrA9Mts2L | | | | |
| Tin-free | 490 (5,000) | 4.1 | 5 ± 0.9 | 416 |
| casting bronze | | | | |
| BrA10Mts2L | | | | |
| OT4 Titanium alloy | 686 (7,000) | 3.0 | 3.5 ± 0.5 | 421 |
| BT4 Titanium alloy | 834 (8,500) | 2.5 | 3.0 ± 0.5 | 423 |
| Copper alloy | 196 (2,000) | 10.4 | 12 ± 1.6 | 389 |
| M1, M2, M3, soft | | | | |
| Copper alloy | 294 (3,000) | 7.0 | 8.5 ± 1.5 | 402 |
| M1, M2, M3, hard | | | | |

Table 3 contains the following references:
σₛ—material strength;
hᵢₛₘᵢₙ—minimum inner shell thickness;
hᵢₛ—nominal inner shell thickness;
V—capacity of the gas cylinder.

Therefore, in a preferred embodiment, the capacity of the gas cylinder can range from 397 l to 404 l when using aluminium alloys such as AMg5M, AMg6M, or the capacity can range from 389 l to 402 l when using copper alloys such as the soft alloy M1, M2, M3 or the hard alloy M1, M2, M3, thus providing sufficient supply of gas stored in gas cylinders 1 in the container and sufficient strength of gas cylinders 1 (with material strength of the inner shell ranging from 255 MPa to 315 MPa and from 196 MPa to 294 MPa, respectively).

In another preferred embodiment, the capacity of the gas cylinder 1 can be 417 l when using the 12KH18N10T alloy, or the capacity can range from 408 l to 416 l when using bronze alloys such as BrA9Mts2L, BrA10Mts2L, thus providing greater supply of gas stored in gas cylinders 1 in the container and greater strength of gas cylinders 1 (with material strength of the inner shell of 530 MPa and ranging from 392 MPa to 490 MPa, respectively).

In another preferred embodiment, the capacity of the gas cylinder 1 can range from 421 l to 423 l when using titanium alloys such as OT4, BT4, thus providing significant supply of gas stored in gas cylinders 1 in the container and significant strength of gas cylinders 1 (with material strength of the inner shell ranging from 686 MPa to 834 MPa).

Table 4 illustrates the effect of various outer shell materials (the outer shell comprising an epoxy matrix) on operating parameters of a gas cylinder.

Calculations were carried out for outer shells made of various materials having an outer diameter D=505 mm, a gas cylinder 1 length L1=2,710 mm, with the inner shell 1made of AMg6M (AMg5M, AMg4,5) and an inner shell wall thickness of 10±2 mm.

TABLE 4

| | Outer shell material | | |
|---|---|---|---|
| | RVMPN | ES | RUSLAN- |
| Parameter | 10-1200 | 13-1260 | VM-650 |
| σₛ₁, kilogram-force | 13,250 | 7,900 | 18,800 |
| per cm² | | | |
| n_{c} | 16 | 27 | 12 |
| nₖ | 20 | 33.5 | 14 |
| h_{c}, mm | 7.68 | 12.96 | 5.76 |
| hₖ, mm | 9.60 | 16.08 | 6.73 |
| h_{Σ} = h_{c} + hₖ, mm | 17.28 | 29.04 | 12.48 |
| dᵢₛ, mm | 470 | 447 | 480 |
| a_{b}, mm | 235 | 223.5 | 240 |
| b_{b}, mm | 151 | 143.5 | 154 |
| lₜ, mm | 2,306 | 2,321 | 2,300 |
| V, mm | 397 | 358 | 414 |
| mᵢₛ, kg | 102 | 96.5 | 104 |
| m_{Σ}, kg | 151 | 248.5 | 68 |
| m_{cy} = m_{π} + m_{Σ}, kg | 253 | 345 | 172 |

Table 4 contains the following references:
σₛ₁—material strength;
n_{c}—number of spiral layers when winding the outer shell of the gas cylinder 1 onto the inner shell;
nₖ—number of annular layers when winding the outer shell of the gas cylinder onto the inner shell;
h_{c}—thickness of spiral layers;
hₖ—thickness of annular layers;
h_{Σ}—total thickness of layers;
dᵢₛ—outer diameter of the inner shell;
a_{b}—height of the inner shell base;
b_{b}—radius of the inner shell base;
lₜ—length of the cowl (the cylindrical part of the inner shell);
V—capacity of the gas cylinder;
mᵢₛ—weight of the inner shell;
m_{Σ}—weight of the layers;
m_{cy}—gas cylinder weight.

Therefore, the inner capacity of the gas cylinder can range from 397 l to 414 l depending on the material of the outer shell of the gas cylinder.

In order to achieve the stated technical effect, gas cylinder parameters were calculated in order to select the optimal arrangement of gas cylinders in the container having set parameters.

The optimal arrangement of gas cylinders in the container provides workability and easy mounting, easy access and comfortable inspection of parts requiring regular maintenance and adjustment. A well thought out arrangement improves serviceability and simplifies maintenance.

The aforementioned calculation of gas cylinder parameters was carried out for a container with a length of 6,058 mm, a width of 2,438 mm and a height of 2896 mm by selecting the maximum possible circle diameters and taking into account the radial expansion of gas cylinders 1 during gas injection, the mounting gaps, and the workability. The outer diameter and thickness of the tube wall for manufacturing the inner shell of the gas cylinder were selected based on the material of the outer shell (material strength and thickness).

Table 5 below lists different variations of gas cylinder arrangement in the container.

TABLE 5

| | | | | Arrangement | | | |
|---|---|---|---|---|---|---|---|
| D1, mm | Dᵢₛ, mm | N | L2, mm | pattern | V_{cy}, l | m_{cy}, kg | V_{co}, l |
| 505(+10; −5) | 470 | 55 | 2,710 + 5 | Vertical | 400(±15) | No more | 22,000 |
| | | | | checkerboard | | than 260 | |
| 505(±5) | 450(453)* | 55 | 2,710 + 5 | Vertical | 348(±5) | 304 | 19,140 |
| | | | | checkerboard | | | |
| 545(±5) | 506 | 40 | 2,710 + 5 | Vertical | 436(±5) | 277 | 17,440 |
| | | | | checkerboard | | | |
| 509(±5) | 470 | 18 | 5,640 + 5 | Horizontal | 950(±5) | 522 | 17,100 |
| | | | | checkerboard | | | |
| 509(±5) | 470 | 18 | 5,640 + 5 | Horizontal | 950(±5) | 522 | 17,100 |
| | | | | inline | | | |
| 545(±5) | 506 | 38 | 2,710 + 5 | Vertical inline | 436(±5) | 277 | 16,568 |
| 545(±5) | 490 | 40 | 2,710 + 5 | Vertical | 408(±5) | 346 | 16,320 |
| | | | | checkerboard | | | |
| 518(+2; −3) | 480 | 40 | 2,710 + 5 | Vertical | 392(±5) | 260 | 15,680 |
| | | | | checkerboard | | | |
| | | | | and inline | | | |
| 545(±5) | 490 | 38 | 2,710 + 5 | Vertical inline | 408(±5) | 346 | 15,504 |
| 518(+2; −3) | 465 | 40 | 2,710 + 5 | Vertical | 367(±5) | 319 | 14,680 |
| | | | | checkerboard | | | |
| | | | | and inline | | | |
| 520(−5) | 480 | 55 | 2,355 + 5 | Vertical | 351(±5) | 230 | 19,305 |
| | | | | checkerboard | | | |
| 480(±5) | 450 | 58 | 2,710 + 5 | Vertical | 351(±5) | 240 | 20,358 |
| | | | | checkerboard | | | |
| 520(−5) | 490 | 55 | 2,710 + 5 | Vertical | 430(−10) | 270 | 23,650 |
| | | | | checkerboard | | | |
| 480(+5) | 470 | 58 | 2,800 | Vertical | 430(−10) | 150 | 24,940 |
| | | | | checkerboard | | | |

*Due to a lack of standard tube size with an outer diameter of 453 mm, a tube having an outer diameter of 450 mm was selected for calculations.
Table 5 contains the following references:
D1—outer diameter of the gas cylinder;
Dᵢₛ—outer diameter of the inner shell;
N—number of gas cylinders 1 in the container;
L2—inner shell length;
V_{cy}—gas cylinder capacity;
m_{cy}—gas cylinder weight;
V_{co}—total capacity of the container.

Calculations and empirical data show that the maximum capacity of a container with set parameters containing gas cylinders with natural gas is achieved when the following gas cylinder requirements are met: the outer diameter D of the gas cylinder ranges from 480 mm to 520 mm, the gas cylinder capacity ranges from over 350 l to 430 l, and the gas cylinders are arranged in the container in a stand-up position and in a checkerboard pattern.

Table 5 shows that, when using a combination of gas cylinder parameters wherein the outer diameter of the gas cylinder is 520 mm and the capacity is over 350 l, an increase in capacity of a container for gas cylinders when the gas cylinders are arranged in the container and are conforming to the above parameters (a standard 20 ft container) is achieved due to the fact that with such gas cylinder parameters it is possible to arrange 55 gas cylinders in the container with set parameters, and in this case, when using gas cylinders with capacity over 350 l (e.g., 351 l), the capacity of the container would exceed 19,250 l (e.g., 19,305 l for gas cylinders with capacity of 351 l), which is greater than that of the prior art solutions specifically described in paragraph 2, page 2 of the disclosure.

On the other hand, an outer diameter of the gas cylinder of 520 mm allows increasing of the gas cylinder capacity to 430 l (with inner diameter of the gas cylinder of 490 mm), thus providing container capacity of 23,650 l, which is significantly greater compared to the prior art solutions for the container of identical size.

Therefore, the results illustrate the possibility of arranging 55 gas cylinders with outer diameter of 520 mm in a 20 ft container and at the same time, the possibility of increasing the capacity of a gas cylinder with outer diameter of 520 mm up to 430 l.

Further, it is apparent that when the outer diameter of a gas cylinder is decreased (e.g., with the gas cylinder outer diameter values of under 520 mm), it is still possible to arrange at least 55 gas cylinders in a container with set parameters, thus also providing an increase in capacity of the container with set parameter up to values exceeding 19,250 l. Furthermore, when the outer diameter of a gas cylinder is decreased to 480 mm, the capacity of the gas cylinder can be increased to 430 l (with the inner diameter of the gas cylinder equal to 470 mm). When at least 55 such gas cylinders are arranged in a 20 ft container, the container capacity would be increased to 23,650 l, significantly exceeding the capacity of the prior art container (19,250 l).

It is apparent that all intermediate combinations of the set parameters also provide, firstly, the arrangement of at least 55 gas cylinders in a 20 ft container, and secondly, the possibility of bringing the capacity of a container with an external diameter within the aforementioned range (including the minimum value) up to any capacity value in the disclosed range (including the maximum value).

Thus, the claimed technical effect is achieved with any combination of gas cylinder parameters (outer diameter ranging from 480 mm to 520 mm and capacity ranging from over 350 l to 430 l) in the present invention.

The above empirical data is provided with respect to a 20 ft container with a length of 6,058 mm, a width of 2,438 mm, and a height of 2,896 mm, however, the technical effect is also achieved with respect to 10 ft containers and 30 ft containers with corresponding proportional changes in the number of gas cylinders arranged in the container.

Preferably, the container 1 for gas cylinders 2 has the length from 2,986 mm to 2,991 mm (according to GOST R 53350-2009), width from 2,433 mm to 2,438 mm (according to GOST R 53350-2009) and height from 2,891 mm to 2,896 mm, or length from 6,052 mm to 6,058 mm (according to GOST R 53350-2009), width from 2,433 mm to 2,438 mm (according to GOST R 53350-2009) and height from 2,891 mm to 2,896 mm, or length from 9,115 mm to 9,125 mm (according to GOST R 53350-2009), width from 2,433 mm to 2,438 mm (according to GOST R 53350-2009) and height from 2,891 mm to 2,896 mm (according to GOST R 53350-2009).

Preferably, each of the gas cylinders 2 has the outer diameter ranged from 480 mm to 520 mm, capacity ranged from over 350 l to 430 l, at least one shell (not shown) with the length ranged from 2,400 mm to 2,870 mm, inner diameter at least 420 mm and outer diameter not more than 520 mm.

In a preferred embodiment, the gas cylinder 2 is intended for transporting, storing and dispensing (including the use as part of gas transportation and storage systems) compressed natural gas and other compressed gases which do not have an aggressive effect on the material of the inner shell under pressure exceeding 0.07 MPa (0.7 kilogram-force per cm²). The gas cylinder 2 is a composite/metal structure consisting of a metal inner shell providing a hermetic seal, a load-bearing composite outer shell, and two necks for connecting connection fittings or valves. The inner shell of the gas cylinder 2 is made of the AMg6M alloy. The reinforcing material in the load-bearing composite outer shell is the RVMPN 10-1200 glass roving. The load-bearing outer shell of the gas cylinder 2 has a diameter of 505 (+10;-5) mm, while the inner shell has a diameter of 470 mm; the length of the inner shell is 2,710 (+5) mm, the capacity of the gas cylinder is 400 (±15) l, and the weight of the gas cylinder is 260 kg.

In a preferred embodiment, 55 gas cylinders 2 are arranged in a 20 ft container with a length of 6,058 mm, a width of 2,438 mm and a height of 2,896 mm, thus providing total container capacity of 22,000 l.

The container 1 for gas cylinders 2 also comprises five pipelines 4 located in the upper part of the framework 3. It should be noted that the quantity of the pipelines 4 is not limiting in the present invention and can be selected depending on the requirements and the quantity of the gas cylinders placed in the container 1 and/or gas cylinders which need to be connected with the pipelines.

The pipelines 4 are connected with the gas cylinders 2 in the upper part of the framework using connection fittings (not shown) mounted on the necks of the gas cylinders 2.

In other non-limiting embodiments, the pipelines 4 can be connected with the gas cylinders 2 by means of any suitable method using any suitable connection means.

Preferably, the pipelines 4 can be welded to connection fittings mounted on the necks of the gas cylinders 2 or connected with the connection fittings by means of another suitable method.

Each of the gas cylinders 2 can comprise only one neck or more necks, if required. Depending on the application different stop and/or safety valves can be mounted on the necks of the gas cylinders 2 without limitation, including fire safety valves.

The container 1 optionally comprises means for controlling the pipelines 4 mounted on the end face of the container 1 and comprising pressure gauges 5 for each of the pipelines 4.

The means for controlling the pipelines 4 can be located in any suitable part of the container 1.

The means for controlling the pipelines 4 can be any suitable control means without limitation.

The means for controlling the pipelines 4 comprise also at least one control valve configured to be opened for gas injection into the gas cylinders 2 and gas supply from the gas cylinders 2, and closed after these procedures. The control valve can be located close to the other control means, for example, pressure gauges 5 on the end face of the container 1, or it can be located at a distance from the other control means in the other part of the container 1. Gas injection into the gas cylinders and/or gas supply from the gas cylinders 2 can be performed using other control valves or other means located in any suitable part of the container 1.

As shown in FIG. 1, the gas cylinders 2 are arranged in the container 1 in a stand-up position in a checkerboard pattern; however, this arrangement of the gas cylinders 2 in the container 1 is non-limiting and represents an example of the most preferred arrangement of the gas cylinders 2 which provides the optimal value of the container 1 capacity.

The container 1 also comprises means for fastening of the gas cylinders 2 to the framework 3 which preferably are located in the upper part of the framework 3 and the lower part of the framework 3.

The means for fastening of the gas cylinders 2 to the framework 3 can be any suitable fastening means for fastening of the gas cylinders 2 to the framework 3.

In an embodiment of the invention, the means for fastening of the gas cylinders 2 to the framework 3 comprise recesses configured as a dome-shaped bowl with a centering hole located in the lower part of the framework 3 for insertion of the gas cylinders 2 in a stand-up position into them.

The dome-shaped bowls are welded to the lower part of the framework 3 in the locations corresponding to the positions of the gas cylinders 2 in the framework 3. The dome-shaped bowls can be configured in such a manner that when inserting the gas cylinders 2 into them the latter are fastened inside a bowl through a close contact between the outer surface of the gas cylinders 2 and the inner surface of the bowl due to the gradual decrease in the bowl inner diameter in the direction from the top part of the bowl to the bottom part of the bowl and presence of the centering hole. Such fastening of the gas cylinders 2 in a bowl can restrict mobility of the lower part of the gas cylinders 2. The bowl can comprise damping elements of elastic material, if required.

In another embodiment, the means for fastening the gas cylinders 2 to the framework 3 can comprise inserts capturing the upper and/or the lower parts of the gas cylinders or threaded nuts mounted on the necks in the upper and/or lower parts of the gas cylinders 2 and channel brackets to which the inserts and/or threaded nuts are fastened. In particular, the necks of the gas cylinders 2 can be fastened to the channel brackets using the inserts mounted on the necks of the gas cylinders and inserted into the corresponding holes in the channel brackets. The channel brackets, in turn, are fastened (for example, welded) to the framework 3. The means for fastening gas cylinders 2 to the framework 3 can further comprise at least two damping inserts mountable on the gas cylinder neck, thus restricting mobility of upper and lower parts of the gas cylinders relative to the container.

The means for fastening of the gas cylinders 2 to the framework 3 can comprise any suitable fastening means located in any suitable part of the framework 3, if required.

A method for arranging gas cylinders 2 in the container 1 according to a preferred embodiment is described below.

In one embodiment, the method for arranging the gas cylinders 2 in the container 1 is performed as follows:

the gas cylinders 2 are arranged in a stand-up position in a checkerboard pattern in the framework 3 of the container 1; and

the pipelines 4 are connected with the gas cylinders 2 in the upper part of the framework 3.

The gas cylinders 2 are fastened to the lower part of the framework 3 and/or the upper part of the framework 3 using fastening means, if required.

In another preferred embodiment, the method for arranging gas cylinders 2 in the container 1 is performed as follows:

the gas cylinders 2 are arranged in the framework 3 of the container 1 by inserting the gas cylinders 2 in a stand-up position in a checkerboard pattern into recesses configured as dome-shaped bowls with centering holes,

the gas cylinders 2 are fastened to the upper part of the framework 3 of the container 1 using inserts mounted on the necks of the gas cylinders 2, with the inserts capturing the necks of the gas cylinders, thus restricting mobility of the upper part of the gas cylinders 2 relative to the container 1. The inserts are inserted into the corresponding holes in channel brackets which, in turn, are fastened to the framework 3.

the pipelines 4 are connected with the gas cylinders 2 in the upper part of the framework 3 by welding connection fittings mounted on the necks of the gas cylinders to the pipelines 4, or are connected in a different manner.

When the gas cylinders 2 are arranged in the container 1, the container 1 contains the gas cylinders 2 into which gas is injected and from which gas is supplied using the known means. The procedures are controlled by valves, pressure gauges 5 and/or other suitable devices.

It should be noted that the described container with gas cylinders and the method for arranging gas cylinders in the container are just some of the preferred embodiments. It is obvious for one skilled in the art that in the present invention variations and modifications can be introduced without deviation from the scope of the invention as defined by the claims below.

1. A container for gas cylinders having an outer diameter ranged from 480 mm to 520 mm and capacity ranged from over 350 1 to 430 1, the container comprising a framework and at least one pipeline positioned to be connected with the gas cylinders in an upper part of the framework.

2. The container of claim 1, wherein the container comprises means for fastening the gas cylinders to the framework.

3. The container of claim 1, wherein the at least one pipeline is connectable with the gas cylinders via at least one connection fitting.

4. The container of claim 2, wherein the means for fastening gas cylinders to the framework are configured to fasten the gas cylinders to an upper part of the framework and/or a lower part of the framework.

5. The container of claim 2 or claim 4, wherein the means for fastening gas cylinders to the framework comprise at least one recess configured to receive the gas cylinder in a stand-up position.

6. The container of claim 5, wherein the recess is a dome-shaped bowl with a centering hole.

7. The container of claim 2 or claim 4, wherein the means for fastening gas cylinders to the framework comprise at least one insert located in the lower part of the framework and/or the upper part of the framework.

8. The container of claim 2 or claim 4, wherein the means for fastening gas cylinders to the framework are configured to fasten the gas cylinders to the upper part of the framework, thus restricting mobility of upper parts of the gas cylinders relative to the container.

9. The container of claim 8, wherein the means for fastening gas cylinders to the framework comprise at least one nut mountable on a gas cylinder neck.

10. The container of claim 2 or claim 4, wherein the means for fastening gas cylinders to the framework are configured to fasten the gas cylinders to the framework in a stand-up position in a checkerboard pattern.

11. The container of claim 2 or claim 4, wherein the means for fastening gas cylinders to the framework comprise at least two damping inserts mountable on a gas cylinder neck, thus restricting mobility of upper and lower parts of the gas cylinders relative to the container.

12. The container of claim 1, wherein the container has a length from 2,986 mm to 2,991 mm, a width from 2,433 mm to 2,438 mm and a height from 2,891 mm to 2,896 mm.

13. The container of claim 1, wherein the container has a length from 6,052 mm to 6,058 mm, a width from 2,433 mm to 2,438 mm and a height from 2,891 mm to 2,896 mm.

14. The container of claim 1, wherein the container has a length from 9,115 mm to 9,125 mm, a width from 2,433 mm to 2,438 mm and a height from 2,891 mm to 2,896 mm.

15. The container of claim 1, wherein the framework is a metal load-bearing framework.

16. The container of claim 1, wherein the container comprises means for controlling at least one pipeline, the means comprising at least one pressure gauge.

17. The container of claim 1, characterized in that the container is intended for use with gas cylinders having an outer diameter of 505 (+10; −5) mm and capacity of 400 (±15) 1.

18. A method for arranging gas cylinders in a container, the gas cylinders having an outer diameter ranged from 480 mm to 520 mm and capacity ranged from over 350 1 to 430 1, the method comprising the steps of:
arranging the gas cylinders in a framework of the container; and
connecting at least one pipeline with the gas cylinders in an upper part of the framework.

19. The method of claim 18, wherein the gas cylinders are arranged in a stand-up position in a checkerboard pattern in the framework.

20. The method of claim 18, wherein the gas cylinders are fastened to the framework.

21. The method of claim 18, wherein the gas cylinders are fastened to an upper part of the framework and/or a lower part of the framework.

22. The method of claim 20 or claim 21, wherein at least one gas cylinder in a stand-up position is fastened to the lower part of the framework by its insertion into a recess configured as a dome-shaped bowl with a centering hole.

23. The method of claim 20 or claim 21, wherein at least one gas cylinder in a stand-up position is fastened to the upper part of the framework, thus restricting mobility of an upper part of the gas cylinders relative to the container.

24. The method of claim 23, wherein the at least one gas cylinder is fastened to the upper and/or lower part of the framework by fastening a gas cylinder neck to the container framework using a nut mounted on the gas cylinder neck.

25. The method of claim 18, characterized in that the method is intended for arranging gas cylinders having an outer diameter of 505 (+10; −5) mm and capacity of 400 (±15) 1.

26. The method of claim 20 or claim 21, wherein at least one gas cylinder is fastened to the framework using at least two damping inserts mountable on a gas cylinder neck, thus restricting mobility of upper and lower parts of the gas cylinders relative to the container.

27. A container with gas cylinders, the container comprising:
a framework;
at least one gas cylinder having an outer diameter ranged from 480 mm to 520 mm and capacity ranged from over 350 1 to 430 1, the at least one gas cylinder arranged in the framework; and
at least one pipeline connected with the at least one gas cylinder in an upper part of the framework.

28. The container of claim 27, wherein the at least one gas cylinder is a gas cylinder for natural gas.

29. The container of claim 28, wherein the at least one gas cylinder is a gas cylinder for pressurized or liquefied gas.

30. The container of claim 27, wherein the at least one gas cylinder is fastened to the framework.

31. The container of claim 30, wherein the at least one gas cylinder is fastened to an upper part of the framework and/or a lower part of the framework.

32. The container of claim 30 or claim 31, wherein fastening of the at least one gas cylinder to the lower part of the framework is provided by insertion of the at least one gas cylinder in a stand-up position into a recess configured as a dome-shaped bowl with a centering hole.

33. The container of claim 30 or claim 31, wherein fastening of the at least one gas cylinder to the upper and/or lower part of the framework is provided by fastening a gas cylinder neck to the container framework using a nut mounted on the gas cylinder neck, thus restricting mobility of the upper and/or lower part of the gas cylinder relative to the container.

34. The container of claim 30 or claim 31, wherein the at least one gas cylinder in a stand-up position is fastened to the upper part of the framework, thus restricting mobility of an upper part of the gas cylinders relative to the container.

35. The container of any one of claims 27-31, wherein the at least one gas cylinder comprises at least one neck and a connection fitting mounted on the at least one neck and connectable with the at least one pipeline.

36. The container of any one of claims 27-31, wherein the at least one gas cylinder comprises at least one safety valve.

37. The container of claim 27, wherein the container comprises means for controlling at least one pipeline, the means comprising at least one pressure gauge and/or at least one control valve.

38. The container of claim 27, comprising at least one gas cylinder having an outer diameter of 505 (+10; −5) mm and capacity of 400 (±15)1.

39. The container of claim 30 or claim 31, wherein the at least one gas cylinder is fastened to the framework using at least two damping inserts mountable on a gas cylinder neck, thus restricting mobility of upper and lower parts of the gas cylinders relative to the container.
